(19) United States
(12) Patent Application Publication
(10) Pub. No.: US 2017/0151756 A1
(43) Pub. Date: Jun. 1, 2017

(54) Adhesive Bonded Structure of Support Component of Display Device and Display Device

(71) Applicants: BOE TECHNOLOGY GROUP CO., LTD., Beijing (CN); K-TRONICS (SUZHOU) TECHNOLOGY CO., LTD., Suzhou, Jiangsu Province (CN)

(72) Inventors: Deli FANG, Beijing (CN); Jianbin GAO, Beijing (CN)

(21) Appl. No.: 15/122,295

(22) PCT Filed: Jan. 22, 2016
(86) PCT No.: PCT/CN2016/071714

§ 371 Date: Aug. 29, 2016

(30) Foreign Application Priority Data
Jul. 17, 2015 (CN) 201510423349.0

(51) Int. Cl. B32B 7/14; B32B 15/04; B32B 5/02

(52) U.S. Cl. CPC B32B 7/14; B32B 5/028; B32B 15/04; B32B 2250/02; B32B 2260/021; B32B 2457/20

(57) ABSTRACT

Embodiments of the an adhesive bonded structure of a support component of a display device includes a first structural member, a second structural member, and an adhesive bonding the first structural member and the second structural member together. The adhesive includes a first adhesive and a second adhesive. The first adhesive has a better deformation resistance than that of the second adhesive, and the second adhesive has a better bonding property than that of the first adhesive.

### TECHNICAL FIELD

The present invention relates to the field of display technology, and in particular to an adhesive bonded structure of a support component of a display device and a display device.

### BACKGROUND

In the field of display technology, and in particular in a support component of a display device, an adhesive bonding process is widely used.

In a traditional adhesive bonding process, only one adhesive such as a glue or a double-sided adhesive tape is used. A double-sided adhesive tape has good performances of resistance to plastic deformation, weather resistance and impact resistance, but has a weak adhesive strength. A glue has a strong adhesive strength, but has poor performances of resistance to plastic deformation, weather resistance and impact resistance. Thus, an adhesive bonded structure obtained by only using a double-sided adhesive tape has a disadvantage of tackless under the effect of an external force, and has a seriously insufficient adhesive strength. An adhesive bonded structure obtained by only using a glue is easy to crack under the effect of a brittleness stress, and has insufficient flexibility, thereby significantly degrading the robustness of a support component of a display device.

In addition, when adhesive bonding is performed by only using a glue, glue overflow is easy to occur. Thus, when adhesive bonding is performed by only using a glue, a special fixture is usually required, and a pre-bonding time thereof is long. Further, the glue overflow will degrade the appearance rating of an adhesive bonded structure.

### SUMMARY

In view of the technical problems in the prior art, embodiments of the present invention provide an adhesive bonded structure of a support component of a display device and a display device. By being bonded by both a first adhesive and a second adhesive, and by complementation between the advantages and disadvantages of two different adhesives, the adhesive bonded structure has both an increased adhesive strength and an increased deformation resistance, thereby improving the robustness of a support component.

An embodiment of the present invention provides an adhesive bonded structure of a support component of a display device. The adhesive bonded structure includes a first structural member, a second structural member, and an adhesive bonding the first structural member and the second structural member together, wherein, the adhesive includes a first adhesive and a second adhesive, the first adhesive has a better deformation resistance than that of the second adhesive, and the second adhesive has a better bonding property than that of the first adhesive.

For example, in corresponding bonding regions of the first structural member and the second structural member, the second adhesive is provided in central portions of the bonding regions, and the first adhesive is provided in peripheral portions of the bonding regions; or

the first adhesive is provided in central portions of the bonding regions, and the second adhesive is provided in peripheral portions of the bonding regions.

For example, in a case where the second adhesive is provided in the central portions of the bonding regions and the first adhesive is provided in the peripheral portions of the bonding regions, the first adhesive provided in the peripheral portions of the bonding regions partially or completely surrounds the second adhesive provided in the central portions of the bonding regions; or

in a case where the first adhesive is provided in the central portions of the bonding regions and the second adhesive is provided in the peripheral portions of the bonding regions, the second adhesive provided in the peripheral portions of the bonding regions partially or completely surrounds the first adhesive provided in the central portions of the bonding regions.

For example, a ratio of a distribution area of the first adhesive in each of the bonding regions to that of the second adhesive in each of the bonding regions is 1:1.

For example, in corresponding bonding regions of the first structural member and the second structural member, the first adhesive is provided in one end of each of the bonding regions, and the second adhesive is provided in an opposite end of each of the bonding regions.

For example, an area of the one end and an area of the opposite end each are equal to one half of an area of each of the bonding regions, and a distribution area of the first adhesive is equal to that of the second adhesive.

For example, the first adhesive or the second adhesive is uniformly distributed in an S-shape.

For example, the first adhesive or the second adhesive is uniformly distributed in a mesh.

For example, the first adhesive is a double-sided adhesive tape, and the second adhesive is a glue.

Another embodiment of the present invention provides a display device, which includes the adhesive bonded structure of a support component of a display device as described above.

For example, the first structural member and the second structural member of the adhesive bonded structure are two metal members of the display device; or

the first structural member and the second structural member are two non-metal members of the display device; or

one of the first and second structural members is a non-metal member of the display device, and the other of the first and second structural members is a metal member of the display device.

Due to being bonded by both the first adhesive and the second adhesive, and due to complementation between the advantages and disadvantages of two different adhesives, the adhesive bonded structure of a support component of a display device provided by an embodiment of the present invention has both an increased adhesive strength and an increased deformation resistance, thus has both an increased impact resistance and an increased weather resistance, and will not subject to tackless and crack due to the brittleness disadvantage and the strength deficiency of an adhesive, thereby improving the robustness of a support component including the adhesive bonded structure.

By including the adhesive bonded structure of a support component of a display device provided by the present invention, the display device provided by an embodiment of the present invention has an improved assembly quality, thereby improving the quality of the display device.

### BRIEF DESCRIPTION OF THE DRAWINGS

FIG. 1 is a sectional view illustrating an adhesive bonded structure according to a first embodiment of the present invention;

FIG. 2 is a top view illustrating an arrangement of two adhesives in the adhesive bonded structure as shown in FIG. 1;

FIG. 3 is a top view illustrating another arrangement of two adhesives in the adhesive bonded structure according to the first embodiment of the present invention;

FIG. 4 is a top view illustrating that a second adhesive in the adhesive bonded structure according to the first embodiment of the present invention is arranged in a mesh;

FIG. 5 is a top view illustrating an arrangement of two adhesives in an adhesive bonded structure according to a second embodiment of the present invention;

FIG. 6 is a sectional view illustrating an adhesive bonded structure according to a third embodiment of the present invention; and

FIG. 7 is a sectional view illustrating an adhesive bonded structure according to a fourth embodiment of the present invention.

### DETAILED DESCRIPTION

In order to make those skilled in the art understand the technical solutions of the present invention better, an adhesive bonded structure of a support component of a display device and a display device provided by the present invention will be further described below in detail with reference to the accompanying drawings and specific embodiments.

### First Embodiment

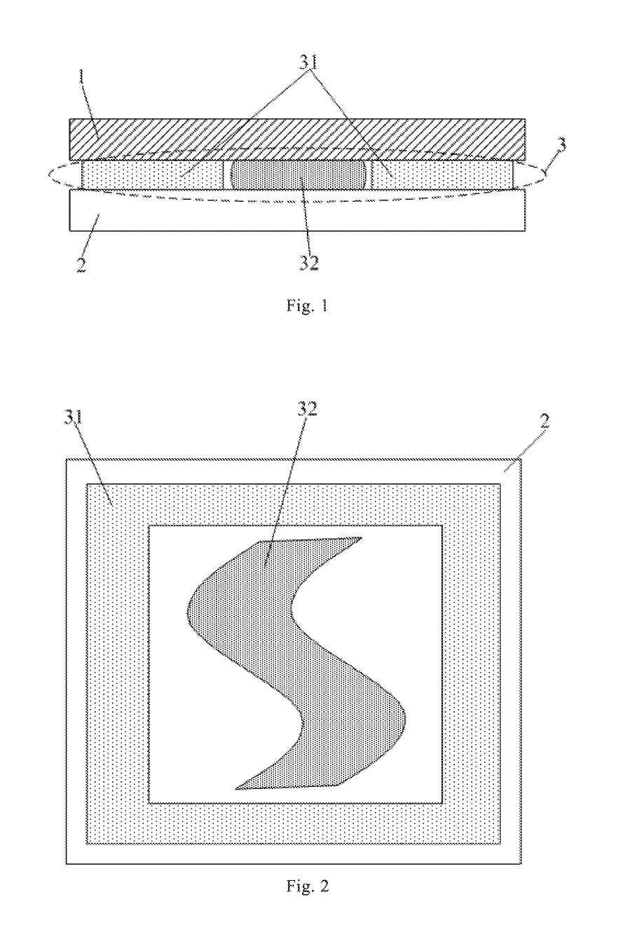

The present embodiment provides an adhesive bonded structure of a support component of a display device. As shown in FIG. 1, the adhesive bonded structure includes a first structural member 1, a second structural member 2, and an adhesive 3 bonding the first structural member 1 and the second structural member 2 together. The adhesive 3 includes a first adhesive 31 and a second adhesive 32, the first adhesive 31 has a better deformation resistance than that of the second adhesive 32, and the second adhesive 32 has a better bonding property than that of the first adhesive 31.

Due to being bonded by both the first adhesive 31 and the second adhesive 32, and due to complementation between the advantages and disadvantages of the two different adhesives, the adhesive bonded structure has both an increased adhesive strength and an increased deformation resistance. The increased deformation resistance of the adhesive bonded structure results in better flexibility of the adhesive bonded structure, thus the adhesive bonded structure has both an increased impact resistance and an increased weather resistance, and will not subject to tackless and crack due to the brittleness disadvantage and the strength deficiency of an adhesive, thereby improving the robustness of a support component including the adhesive bonded structure.

In the present embodiment, in corresponding bonding regions (which are, for example, corresponding regions of two surfaces, which face to each other, of the first structural member 1 and the second structural member 2 as shown in FIG. 1) of the first structural member 1 and the second structural member 2, the second adhesive 32 is provided in central portions of the bonding regions, and the first adhesive 31 is provided in peripheral portions of the bonding regions. The central portions and the peripheral portions may not overlap. With such an arrangement, both the first adhesive 31 and the second adhesive 32 not only present their bonding advantages but also form complementation of their bonding disadvantages in the adhesive bonded structure. In this way, a sufficient adhesive strength and a sufficient deformation resistance of the adhesive bonded structure are ensured, thereby preventing the adhesive bonded structure from tackless and crack.

Here, the first adhesive 31 provided in the peripheral portions of the bonding regions may completely surround the second adhesive 32 provided in the central portions of the bonding regions, as shown in FIG. 2. The first adhesive 31 may be an adhesive in a solid state, and the second adhesive 32 may be an adhesive in a liquid state. With such an arrangement, in addition to ensuring a sufficient adhesive strength and a sufficient deformation resistance of the adhesive bonded structure, the first adhesive 31 can limit the second adhesive 32 in a separate space to prevent the second adhesive 32 from overflowing, thereby increasing the appearance rating of the adhesive bonded structure.

In addition, compared with a case where adhesive bond is performed by using only the second adhesive 32 in the prior art, in a case where adhesive bond is performed by using both the first adhesive 31 and the second adhesive 32, since the arrangement of the first adhesive 31 can avoid glue overflow, a special fixture for adhesive bond is not required; further, since the first adhesive 31 can bond the first structural member 1 and the second structural member 2 together timely, the pre-bonding time of the adhesive bond is shortened. However, in the case where adhesive bond is performed by using only the second adhesive 32, since the second adhesive 32 needs a long time to cure, the pre-bonding time of the adhesive bond is long.

It should be noted that, the first adhesive 31 may not completely surround the second adhesive 32. Since the second adhesive 32 is provided in the central portions of the bonding regions, the first adhesive 31 is provided in the peripheral portions of the bonding regions, and the second adhesive 32 is generally a viscous liquid, the second adhesive 32 will not overflow to the exterior of a bonding region after extending, even if the first adhesive 31 does not completely surround the second adhesive 32, thereby increasing the appearance rating of the adhesive bonded structure.

In the present embodiment, a ratio of a distribution area of the first adhesive 31 in each of the bonding regions to a distribution area of the second adhesive 32 in each of the bonding regions may be set arbitrarily, as long as it is ensured that the first structural member 1 and the second structural member 2 have a sufficient adhesive strength and a sufficient deformation resistance after being bonded together by the two adhesives. Preferably, a ratio of a distribution area of the first adhesive 31 in each of the bonding regions to that of the second adhesive 32 in each of the bonding regions is 1:1.

In the present embodiment, the second adhesive 32 is uniformly distributed in an S-shape, as shown in FIG. 2. With such an arrangement, on one hand, it is possible to prevent the second adhesive 32 from overflowing to the exterior of each of the bonding regions in a case where the second adhesive 32 extends to increase a bonding area thereof, thereby avoiding the degradation of the appearance rating of the adhesive bonded structure. On the other hand, an amount of the second adhesive 32 can be decreased while a sufficient adhesive strength is ensured, thereby reducing the bonding cost of the adhesive bonded structure.

In the present embodiment, the first adhesive 31 is uniformly distributed in a mesh. With such an arrangement, on one hand, an amount of the first adhesive 31 can be decreased while a sufficient deformation resistance is ensured, thereby reducing the bonding cost of the adhesive bonded structure. On the other hand, compared with a case where the first adhesive 31 is distributed in a surface, in a case where the first adhesive 31 is distributed in spaced dots, the flexibility of the adhesive bonded structure bonded by the first adhesive 31 can be further increased, so that the adhesive bonded structure is more difficult to subject to tackless.

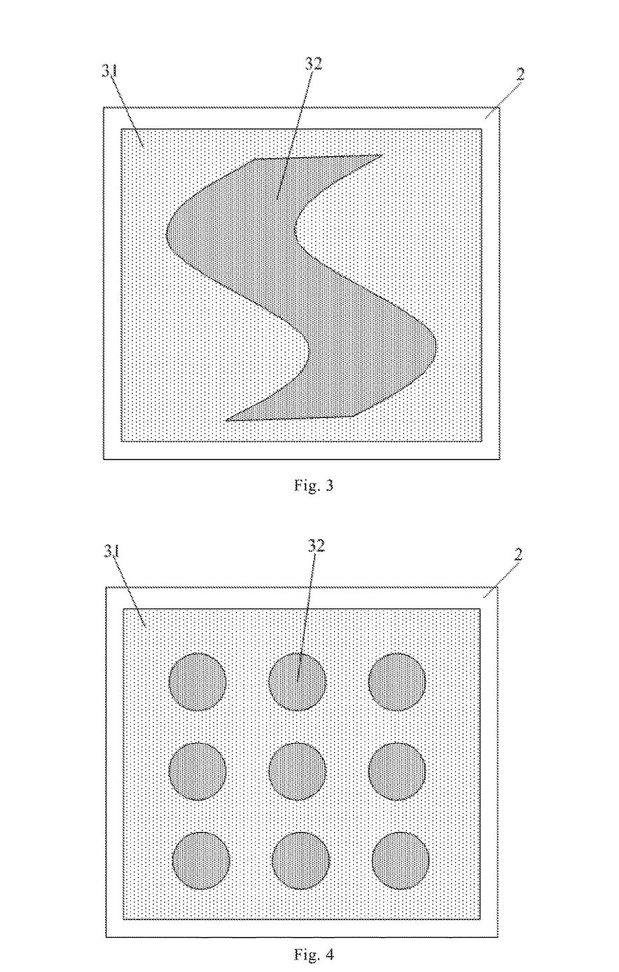

It should be noted that, in the present embodiment, corresponding edges of the first adhesive 31 and the second adhesive 32 may be in contact with each other (i.e., abut on each other), as shown in FIG. 3, or may not be in contact with each other, that is, corresponding edges of the first adhesive 31 and the second adhesive 32 are arranged with an interval therebetween, and the interval is filled with air, as shown in FIG. 2.

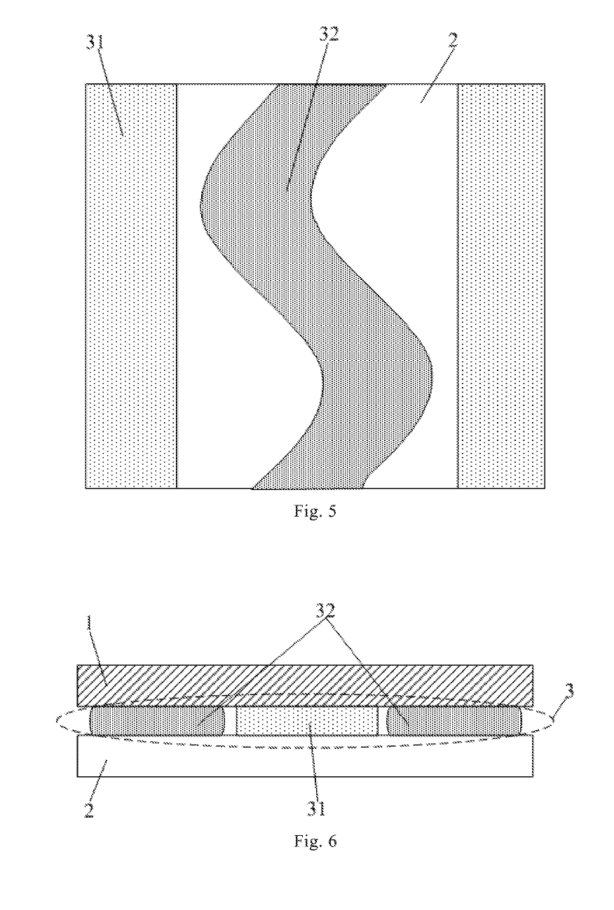

In addition, the second adhesive 32 may be uniformly distributed in a mesh, and the first adhesive 31 may be distributed in any shape, as shown in FIG. 4. Alternatively, the first adhesive 31 may be uniformly distributed in an S-shape, and the second adhesive 32 may be distributed in any shape.

It should be noted that, each of the first adhesive 31 and the second adhesive 32 may be distributed in another shape, such as a rectangle, a triangle, a polygon, or the like.

In the present embodiment, the first adhesive 31 may be a double-sided adhesive tape, and the second adhesive 32 may be a glue. Certainly, the first adhesive 31 may be another adhesive in a solid state, and the second adhesive 32 may be another adhesive in a liquid state. Materials of the first adhesive 31 and the second adhesive 32 are not specifically limited, and any two different adhesives that can complementarily bonding first structural member 1 and the second structural member 2 together fall into the protection scope of the present invention.

### Second Embodiment

The present embodiment provides an adhesive bonded structure of a support component of a display device. The present embodiment differs from the first embodiment in that, the first adhesive 31 provided in the peripheral portions of the bonding regions partially surrounds the second adhesive 32 provided in the central portions of the bonding regions, as shown in FIG. 5.

With such an arrangement, the first adhesive 31 can partially surround the second adhesive 32 while a sufficient adhesive strength and a sufficient deformation resistance are ensured. As a result, the overflow of the second adhesive 32 is reduced, and the appearance rating of a portion of the adhesive bonded structure is increased.

Other configurations of the adhesive bonded structure of a support component of a display device according to the present embodiment are the same as those of the adhesive bonded structure according to the first embodiment, and detailed description thereof is omitted.

### Third Embodiment

The present embodiment provides an adhesive bonded structure of a support component of a display device. The present embodiment differs from the first embodiment in that, in corresponding bonding regions of the first structural member 1 and the second structural member 2, the first adhesive 31 is provided in central portions of the bonding regions, and the second adhesive 32 is provided in peripheral portions of the bonding regions, as shown in FIG. 6.

Also, with such an arrangement, both the first adhesive 31 and the second adhesive 32 not only present their bonding advantages but also form complementation of their bonding disadvantages in the adhesive bonded structure. In this way, a sufficient adhesive strength and a sufficient deformation resistance of the adhesive bonded structure are ensured, thereby preventing the adhesive bonded structure from tackless and crack.

In the present embodiment, the second adhesive 32 provided in the peripheral portions of the bonding regions may completely surround the first adhesive 31 provided in the central portions of the bonding regions. Since the first adhesive 31 is generally an adhesive in a solid state and the second adhesive 32 is generally an adhesive in a liquid state, with such an arrangement, although a sufficient adhesive strength and a sufficient deformation resistance can be ensured, the second adhesive 32 may overflow due to being provided in the peripheral portions of the bonding regions. Thus, the arrangement of the first adhesive 31 and the second adhesive 32 in the present embodiment is mainly applicable to an adhesive bonded structure which does not require a high appearance rating.

It should be noted that, the second adhesive 32 provided in the peripheral portions of the bonding regions may partially surround the first adhesive 31 provided in the central portions of the bonding regions.

Other configurations of the adhesive bonded structure of a support component of a display device according to the present embodiment are the same as those of the adhesive bonded structure according to the first embodiment, and detailed description thereof is omitted.

### Fourth Embodiment

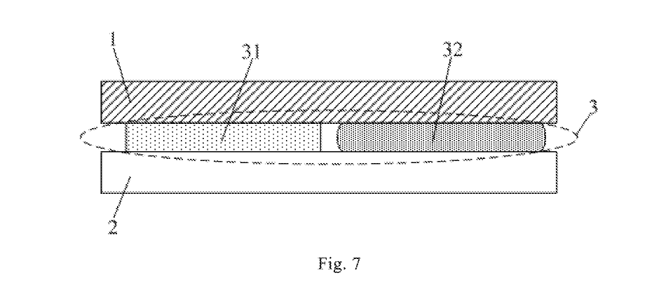

The present embodiment provides an adhesive bonded structure of a support component of a display device. The present embodiment differs from the first to third embodiments in that, in corresponding bonding regions of the first structural member 1 and the second structural member 2, the first adhesive 31 is provided in one end of each of the bonding regions, and the second adhesive 32 is provided in an opposite end of each of the bonding regions, as shown in FIG. 7.

Also, with such an arrangement, both the first adhesive 31 and the second adhesive 32 not only present their bonding advantages but also form complementation of their bonding disadvantages in the adhesive bonded structure. In this way, a sufficient adhesive strength and a sufficient deformation resistance of the adhesive bonded structure are ensured, thereby preventing the adhesive bonded structure from tackless and crack. Thus, the robustness of the support component is improved.

In the present embodiment, an area of the one end and an area of the opposite end each may be equal to one half of an area of each of the bonding regions, and a distribution area of the first adhesive 31 is equal to that of the second adhesive 32. With such an arrangement, the first structural member 1 and the second structural member 2 can have a sufficient adhesive strength and a sufficient deformation resistance after being bonded together by the first adhesive 31 and the second adhesive 32, thereby preventing the adhesive bonded structure from tackless and crack.

It should be noted that, an area of the one end and an area of the opposite end each may not be equal to each other, and a distribution area of the first adhesive 31 may not be equal to that of the second adhesive 32. For example, they may be set with a predetermined ratio. Specifically, a ratio of a distribution area of the first adhesive 31 to that of the second adhesive 32 may be 1:2 or 2:1, as long as a sufficient adhesive strength and a sufficient deformation resistance of the adhesive bonded structure are ensured.

It also should be noted that, since the first adhesive 31 is generally an adhesive in a solid state and the second adhesive 32 is generally an adhesive in a liquid state, with the present arrangement, although a sufficient adhesive strength and a sufficient deformation resistance of the adhesive bonded structure can be ensured, the second adhesive 32 may overflow due to being provided in the opposite end of each of the bonding regions. Thus, the distribution positions of the first adhesive 31 and the second adhesive 32 in the present embodiment is mainly applicable to an adhesive bonded structure which does not require a high appearance rating of the opposite end.

Other configurations of the adhesive bonded structure of a support component of a display device according to the present embodiment are the same as those of the adhesive bonded structure according to the first embodiment, and detailed description thereof is omitted.

In the adhesive bonded structure of a support component of a display device according to any one of the first to fourth embodiments, due to being bonded by both the first adhesive and the second adhesive, and due to complementation between the advantages and disadvantages of the two different adhesives, the adhesive bonded structure has both an increased adhesive strength and an increased deformation resistance, thus has both an increased impact resistance and an increased weather resistance, and will not subject to luckless and crack due to the brittleness disadvantage and the strength deficiency of an adhesive, thereby improving the robustness of a support component including the adhesive bonded structure.

### Fifth Embodiment

The present embodiment provides a display device, which includes the adhesive bonded structure of a support component of a display device according to any one of the first to fourth embodiments.

In the present embodiment, the first structural member and the second structural member of the adhesive, bonded structure may be two metal members of the display device.

It should be noted that, the first structural member and the second structural member of the adhesive bonded structure may be two non-metal members of the display device. Alternatively, one of the first and second structural members of the adhesive bonded structure may be a non-metal member of the display device, and the other of the first and second structural members may be a metal member of the display device. That is, the adhesive bonded structure can be widely adopted in a display device, and various metal members or non-metal members may be adhesive bonded together.

By including the adhesive bonded structure according to any one of the first to fourth embodiments, the display device has an improved assembly quality, thereby improving the quality of the display device.

The display device may be any product or component having a display function, such as a mobile phone, a tablet computer, a television, a display, a laptop computer, a digital photo frame, a navigator, and the like

It should be understood that the aforementioned embodiments are merely exemplary embodiments used for describing the principle of the present invention, but the present invention is not limited thereto. For a person of ordinary skill in the art, various variations and improvements may be made without departing from the spirit and essence of the present invention, and those variations and improvements also fall within the protection scope of the present invention.

1. An adhesive bonded structure of a support component of a display device, comprising a first structural member, a second structural member, and an adhesive bonding the first structural member and the second structural member together, wherein, the adhesive comprises a first adhesive and a second adhesive, the first adhesive has a better deformation resistance than that of the second adhesive, and the second adhesive has a better bonding property than that of the first adhesive.

2. The adhesive bonded structure according to claim 1, wherein, in corresponding bonding regions of the first structural member and the second structural member, the second adhesive is provided in central portions of the bonding regions, and the first adhesive is provided in peripheral portions of the bonding regions; or
the first adhesive is provided in central portions of the bonding regions, and the second adhesive is provided in peripheral portions of the bonding regions.

3. The adhesive bonded structure according to claim 2, wherein,
in a case where the second adhesive is provided in the central portions of the bonding regions and the first adhesive is provided in the peripheral portions of the bonding regions, the first adhesive provided in the peripheral portions of the bonding regions partially or completely surrounds the second adhesive provided in the central portions of the bonding regions; or
in a case where the first adhesive is provided in the central portions of the bonding regions and the second adhesive is provided in the peripheral portions of the bonding regions, the second adhesive provided in the peripheral portions of the bonding regions partially or completely surrounds the first adhesive provided in the central portions of the bonding regions.

4. The adhesive bonded structure according to claim 2, wherein, a ratio of a distribution area of the first adhesive in each of the bonding regions to that of the second adhesive in each of the bonding regions is 1:1.

5. The adhesive bonded structure according to claim 1, wherein, in corresponding bonding regions of the first structural member and the second structural member, the first adhesive is provided in one end of each of the bonding regions, and the second adhesive is provided in an opposite end of each of the bonding regions.

6. The adhesive bonded structure according to claim 5, wherein, an area of the one end and an area of the opposite end each are equal to one half of an area of each of the bonding regions, and a distribution area of the first adhesive is equal to that of the second adhesive.

7. The adhesive bonded structure according to claim 2, wherein, the first adhesive or the second adhesive is uniformly distributed in an S-shape.

8. The adhesive bonded structure according to claim 2, wherein, the first adhesive or the second adhesive is uniformly distributed in a mesh.

9. The adhesive bonded structure according to claim 1, wherein, the first adhesive is a double-sided adhesive tape, and the second adhesive is a glue.

10. A display device, comprising the adhesive bonded structure of a support component of a display device according to claim 1.

11. The display device according to claim 10, wherein, the first structural member and the second structural member of the adhesive bonded structure are two metal members of the display device; or
the first structural member and the second structural member are two non-metal members of the display device; or
one of the first and second structural members is a non-metal member of the display device, and the other of the first and second structural members is a metal member of the display device.

12. The adhesive bonded structure according to claim 3, wherein, a ratio of a distribution area of the first adhesive in each of the bonding regions to that of the second adhesive in each of the bonding regions is 1:1.

13. The adhesive bonded structure according to claim 5, wherein, the first adhesive or the second adhesive is uniformly distributed in an S-shape.

14. The adhesive bonded structure according to claim 5, wherein, the first adhesive or the second adhesive is uniformly distributed in a mesh.

15. The display device according to claim 11, wherein, in corresponding bonding regions of the first structural member and the second structural member, the second adhesive is provided in central portions of the bonding regions, and the first adhesive is provided in peripheral portions of the bonding regions; or
the first adhesive is provided in central portions of the bonding regions, and the second adhesive is provided in peripheral portions of the bonding regions.

16. The display device according to claim 15, wherein,
in a case where the second adhesive is provided in the central portions of the bonding regions and the first adhesive is provided in the peripheral portions of the bonding regions, the first adhesive provided in the peripheral portions of the bonding regions partially or completely surrounds the second adhesive provided in the central portions of the bonding regions; or
in a case where the first adhesive is provided in the central portions of the bonding regions and the second adhesive is provided in the peripheral portions of the bonding regions, the second adhesive provided in the peripheral portions of the bonding regions partially or completely surrounds the first adhesive provided in the central portions of the bonding regions.

17. The display device according to claim 11, wherein, in corresponding bonding regions of the first structural member and the second structural member, the first adhesive is provided in one end of each of the bonding regions, and the second adhesive is provided in an opposite end of each of the bonding regions.

18. The display device according to claim 17, wherein, an area of the one end and an area of the opposite end each are equal to one half of an area of each of the bonding regions, and a distribution area of the first adhesive is equal to that of the second adhesive.

19. The display device according to claim 15, wherein, the first adhesive or the second adhesive is uniformly distributed in an S-shape.

20. The display device according to claim 15, wherein, the first adhesive or the second adhesive is uniformly distributed in a mesh.
